(19) United States
(12) Patent Application Publication
(10) Pub. No.: US 2005/0177681 A1
(43) Pub. Date: Aug. 11, 2005

(54) Storage system

(75) Inventors: Kazuhisa Fujimoto, Kokubunji (JP); Yasuo Inoue, Idawara (JP); Mutsumi Hosoya, Fujimi (JP); Kentaro Shimada, Tokyo (JP); Naoki Watanabe, Sagamihara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/031,556

(22) Filed: Jan. 7, 2005

Related U.S. Application Data
(63) Continuation of application No. 10/820,964, filed on Apr. 7, 2004.

(30) Foreign Application Priority Data
Feb. 10, 2004 (JP) 2004-032810

(51) Int. Cl. G06F 12/00; G06F 15/16

(52) U.S. Cl. 711/112; 711/113; 711/170; 709/203

(57) ABSTRACT

A storage system is comprised of an interface unit 10 which has an interface with a server 3 or hard drives 2, a memory unit 21 which has a cache memory module 126 for storing data to be read from/written to the server 3 or the hard drives 2 and a control information memory module 127 for storing control information of the system, a processor unit 81 which has a microprocessor for controlling the read/write of data between the server 3 and the hard drives 2, and an interconnection 31, wherein the interface unit 10, memory unit 21 and processor unit 81 are interconnected with the interconnection 31.

### CROSS-REFERENCES TO RELATED APPLICATIONS

This application relates to and claims priority from Japanese Patent Application No. 2004-032810, filed on Feb. 10, 2004, the entire disclosure of which is incorporated herein by reference.

### BACKGROUND OF THE INVENTION

1. Field of the Invention

The present invention relates to a storage system which can expand the configuration scalably from small scale to large scale.

2. Description of the Related Art

Storage systems for storing data to be processed by information processing systems are now playing a central role in information processing systems. There are many types of storage systems, from small scale configurations to large scale configurations.

For example, the storage system with the configuration shown in FIG. 20 is disclosed in U.S. Pat. No. 6,385,681. This storage system is comprised of a plurality of channel interface (hereafter “IF”) units 11 for executing data transfer with a computer (hereafter “server”) 3, a plurality of disk IF units 16 for executing data transfer with hard drives 2, a cache memory unit 14 for temporarily storing data to be stored in the hard drives 2, a control information memory unit 15 for storing control information on the storage system (e.g. information on the data transfer control in the storage system 8, and data management information to be stored on the hard drives 2), and, hard drives 2. The channel IF unit 11, disk IF unit 16 and cache memory unit 14 are connected by the interconnection 41, and the channel IF unit 11, disk IF unit 16 and control information memory unit 15 are connected by the interconnection 42. The interconnection 41 and the interconnection 42 are comprised of common buses and switches.

According to the storage system disclosed in U.S. Pat. No. 6,385,681, in the above configuration of one storage system 8, the cache memory unit 14 and the control memory unit 15 can be accessed from all the channel IF units 11 and disk IF units 16.

In the prior art disclosed in U.S. Pat. No. 6,542,961, a plurality of disk array system 4 are connected to a plurality of servers 3 via the disk array switches 5, as FIG. 21 shows, and the plurality of disk array systems 4 are managed as one storage system 9 by the means for system configuration management 60, which is connected to the disk array switches 5 and each disk array system 4.

### SUMMARY OF THE INVENTION

Companies now tend to suppress initial investments for information processing systems while expanding information processing systems as the business scale expands. Therefore the scalability of cost and performance for expanding the scale with a reasonable investment as the business scale expands, while maintaining a small initial investment is demanded for storage systems. Here the scalability of cost and performance of prior art will be examined.

The performance required for a storage system (number of times of input/output of data per unit time and data transfer volume per unit time) is increasing each year. So in order to support performance improvements in the future, the data transfer processing performance of the channel IF unit 11 and the disk IF unit 16 of the storage system disclosed in U.S. Pat. No. 6,385,681 must also be improved.

In the technology of U.S. Pat. No. 6,385,681 however, all the channel IF units 11 and all the disk IF units 16 control data transfer between the channel IF unit 11 and the disk IF unit 16 via the cache memory unit 14 and the control information memory unit 15. Therefore if the data transfer processing performance of the channel IF unit 11 and the disk IF unit 16 improves, the access load to the cache memory unit 14 and the control information memory unit increases. This results in an access load bottleneck, which makes it difficult to improve performance of the storage system 8 in the future. In other words, the scalability of performance cannot be guaranteed.

In the case of the technology of U.S. Pat. No. 6,542,961, on the other hand, the number of connectable disk array system 4 and servers 3 can be increased by increasing the number of ports of the disk-array-switch 5 or by connecting a plurality of disk-array-switches 5 in multiple stages. In other words, the scalability of performance can be guaranteed.

However, in the technology of U.S. Pat. No. 6,542,961, the server 3 accesses the disk array system 4 via the disk-array-switches 5. Therefore in the interface unit with the server 3 of the disk-array-switch 5, the protocol between the server and the disk-array-switch is transformed to a protocol in the disk-array-switch, and in the interface unit with the disk array system 4 of the disk-array-switch 5, the protocol in the disk-array-switch is transformed to a protocol between the disk-array-switch and the disk array system, that is, a double protocol transformation process is generated. Therefore the response performance is poor compared with the case of accessing the disk array system directly, without going through the disk-array-switch.

If cost is not considered, it is possible to improve the access performance in U.S. Pat. No. 6,385,681 by increasing the scale of the cache memory unit 14 and the control information memory unit. However, in order to access the cache memory unit 14 or the control information memory unit 15 from all the channel IF units 11 and the disk IF units 16, it is necessary to manage the cache memory unit 14 and the control information memory unit 15 as one shared memory space respectively. Because of this, if the scale of the cache memory unit 14 and the control information memory unit 15 is increased, decreasing the cost of the storage system in a small scale configuration is difficult, and providing a storage system with a small scale configuration at low cost becomes difficult.

To solve the above problems, one aspect of the present invention is comprised of the following configuration. Specifically, the present invention is a storage system comprising an interface unit that has a connection unit with a computer or a hard disk drive, a memory unit for storing data to be transmitted/received with the computer or hard disk drive and control information, a processor unit that has a microprocessor for controlling data transfer between the computer and the hard disk drive, and a disk unit, wherein the interface unit, memory unit and processor unit are mutually connected by an interconnection.

In the storage system according to the present invention, the processor unit instructs data transfer concerning reading data or writing data requested from the computer by the processor unit exchanging control information between the interface unit and the memory unit.

A part or all of the interconnection may be separated into an interconnection for transferring data or an interconnection for transferring control information. The interconnection may be further comprised of a plurality of switch units.

Another aspect of the present invention is comprised of the following configuration. Specifically, the present invention is a storage system wherein a plurality of clusters are connected via a communication network. In this case, each cluster further comprises an interface unit that has a connection unit with a computer or a hard disk drive, a memory unit for storing data to be read/written from/to the computer or the hard disk drive and the control information of the system, a processor unit that has a microprocessor for controlling read/write of the data between the computer and the hard disk drive, and a disk unit. The interface unit, memory unit and processor unit in each cluster are connected to the respective units in another cluster via the communication network.

The interface unit, memory unit and processor unit in each cluster may be connected in the cluster by at least one switch unit, and the switch unit of each cluster may be interconnected by a connection path.

Each cluster may be interconnected by interconnecting the switch units of each cluster via another switch.

As another aspect, the interface unit in the above mentioned aspect may further comprise a processor for protocol processing. In this case, protocol processing may be performed by the interface unit, and data transfer in the storage system may be controlled by the processor unit.

Problems and solutions thereof that the present application discloses will be described by the section on embodiments of the present invention and the drawings.

### BRIEF DESCRIPTION OF THE DRAWINGS

FIG. 1 is a diagram depicting a configuration example of the storage system 1;

FIG. 2 is a diagram depicting a detailed configuration example of the interconnection of the storage system 1;

FIG. 3 is a diagram depicting another configuration example of the storage system 1;

FIG. 4 is a detailed configuration example of the interconnection shown in FIG. 3;

FIG. 5 is a diagram depicting a configuration example of the storage system;

FIG. 6 is a diagram depicting a detailed configuration example of the interconnection of the storage system;

FIG. 7 is a diagram depicting another detailed configuration example of the interconnection of the storage system;

FIG. 8 is a diagram depicting a configuration example of the interface unit;

FIG. 9 is a diagram depicting a configuration example of the processor unit;

FIG. 10 is a diagram depicting a configuration example of the memory unit;

FIG. 11 is a diagram depicting a configuration example of the switch unit;

FIG. 12 is a diagram depicting an example of the packet format;

FIG. 13 is a diagram depicting a configuration example of the application control unit;

FIG. 14 is a diagram depicting an example of the storage system mounted in the rack

FIG. 15 is a diagram depicting a configuration example of the package and the backplane;

FIG. 16 is a diagram depicting another detailed configuration example of the interconnection;

FIG. 17 is a diagram depicting a connection configuration example of the interface unit and the external unit;

FIG. 18 is a diagram depicting another connection configuration example of the interface unit and the external unit;

FIG. 19 is a diagram depicting another example of the storage system mounted in the rack;

FIG. 20 is a diagram depicting a configuration example of a conventional storage system;

FIG. 21 is a diagram depicting another configuration example of a conventional storage system;

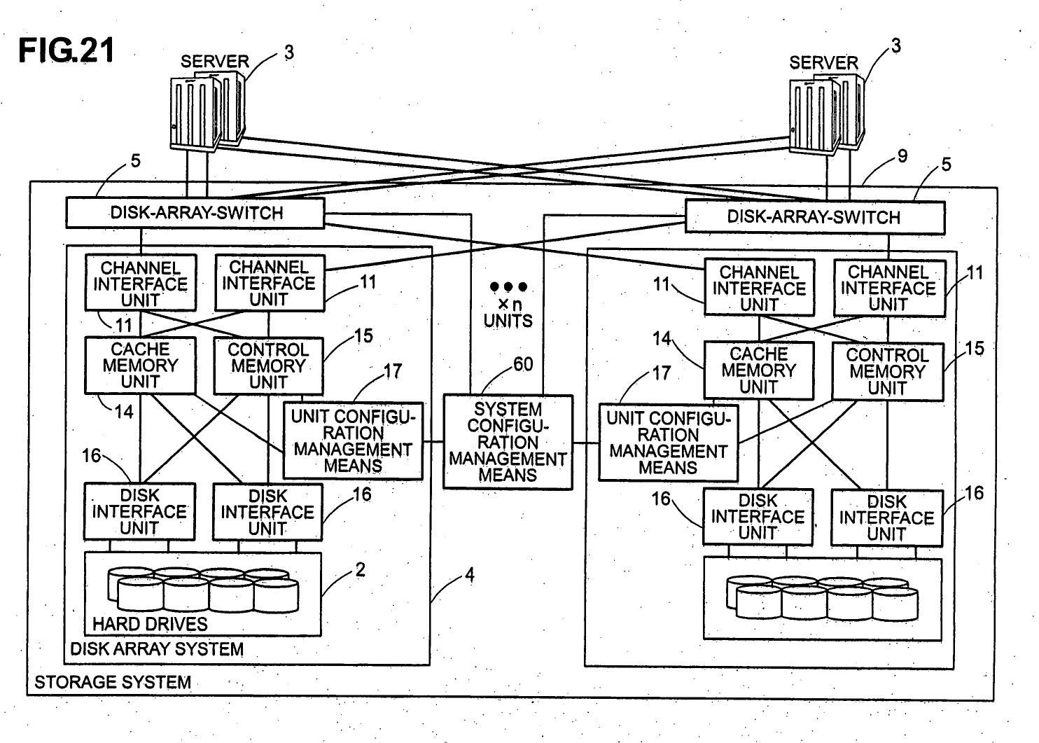

FIG. 22 is a flow chart depicting the read operation of the storage system 1; and

FIG. 23 is a flow chart depicting the write operation of the storage system 1.

### DESCRIPTION OF THE PREFERRED EMBODIMENTS

Embodiments of the present invention will now be described with reference to the accompanying drawings.

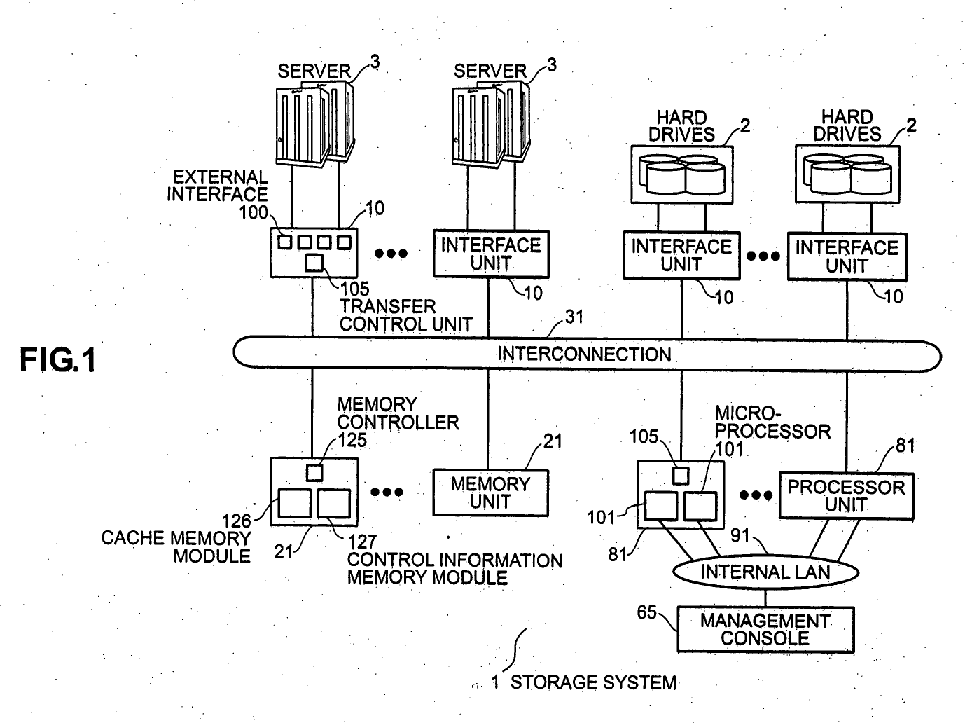

FIG. 1 is a diagram depicting a configuration example of the storage system according to the first embodiment. The storage system 1 is comprised of interface units 10 for transmitting/receiving data to/from a server 3 or hard drives 2, processor units 81, memory units 21 and hard drives 2. The interface unit 10, processor unit 81 and the memory unit 21 are connected via the interconnection 31.

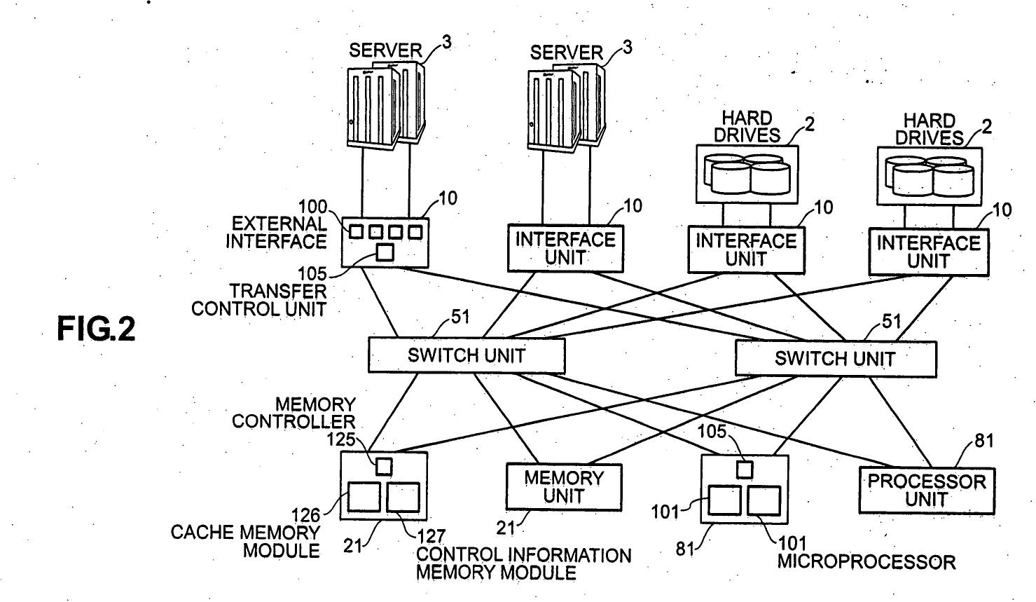

FIG. 2 is an example of a concrete configuration of the interconnection 31.

The interconnection 31 has two switch units 51. The interface units 10, processor unit 81 and memory unit 21 are connected to each one of the two switch units 51 via one communication path respectively. In this case, the communication path is a transmission link comprised of one or more signal lines for transmitting data and control information. This makes it possible to secure two communication routes between the interface unit 10, processor unit 81 and memory unit 21 respectively, and improve reliability. The above number of units or number of lines are merely an example, and the numbers are not limited to these. This can be applied to all the embodiments to be described herein below.

The interconnection shown as an example uses switches, but critical here is that [the units] can be interconnected so that control information and data are transferred, so [the interconnection] may be comprised of buses, for example.

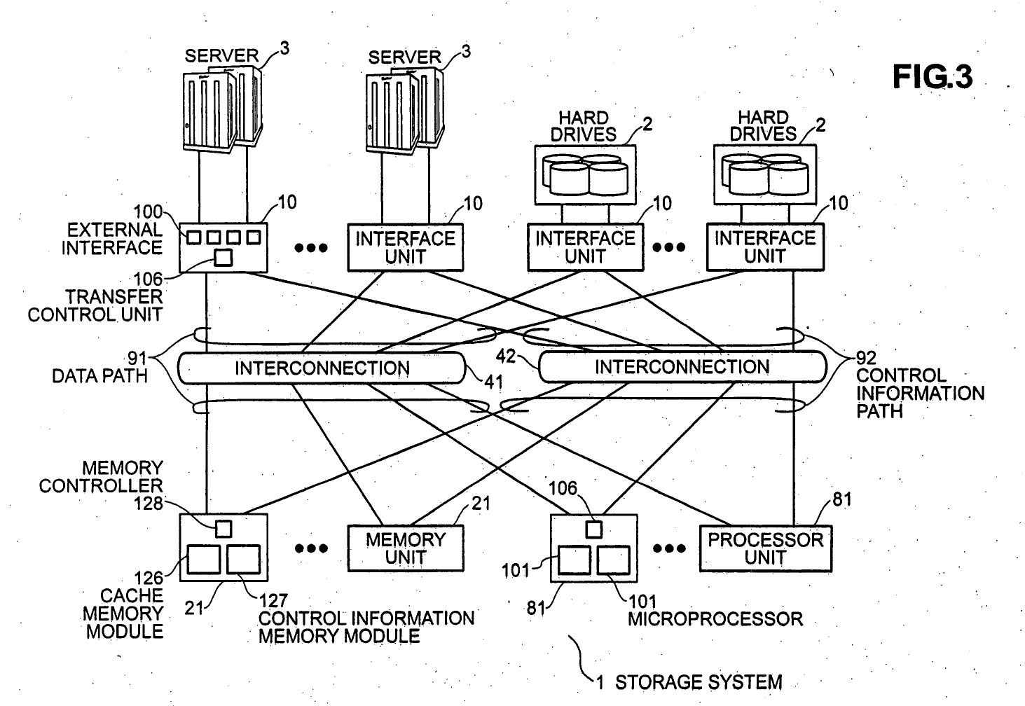

Also a FIG. 3 shows, the interconnection 31 may be separated into the interconnection 41 for transferring data and the interconnection 42 for transferring control information. This prevents the mutual interference of the data transfer and the control information transfer, compared with the case of transferring data and control information by one communication path (FIG. 1). As a result, the transfer performance of data and control information can be improved.

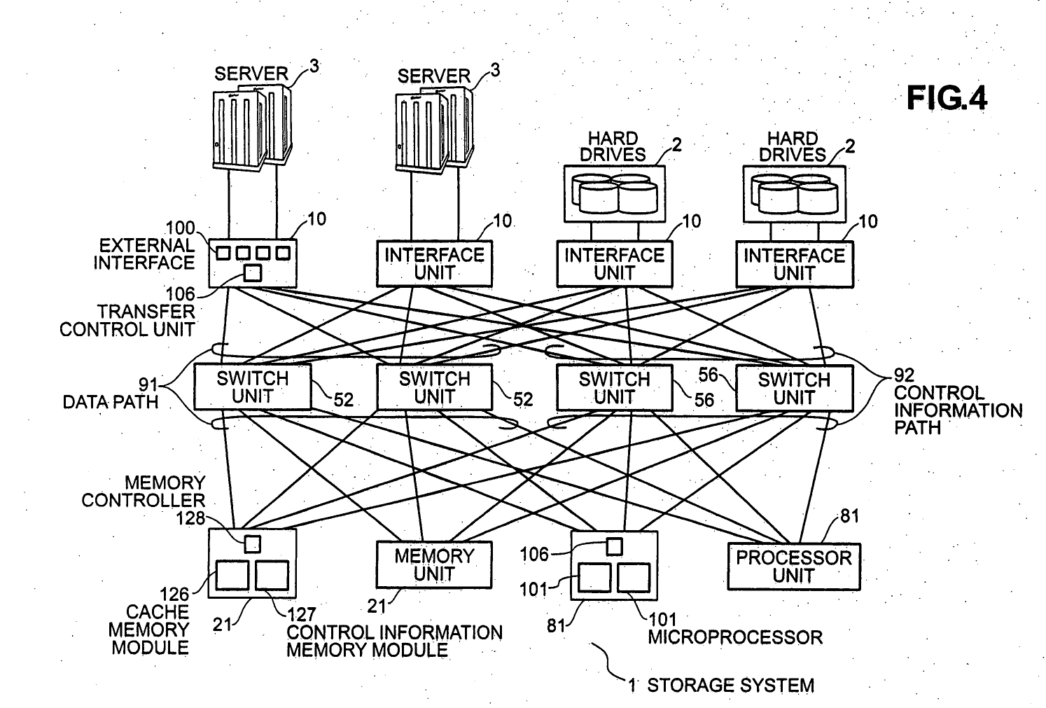

FIG. 4 is a diagram depicting an example of a concrete configuration of the interconnections 41 and 42. The interconnections 41 and 42 have two switch units 52 and 56 respectively. The interface unit 10, processor unit 81 and memory unit 21 are connected to each one of the two switch units 52 and two switch units 56 via one communication path respectively. This makes it possible to secure two data paths 91 and two control information paths 92 respectively between the interface unit 10, processor unit 81 and memory unit 21, and improve reliability.

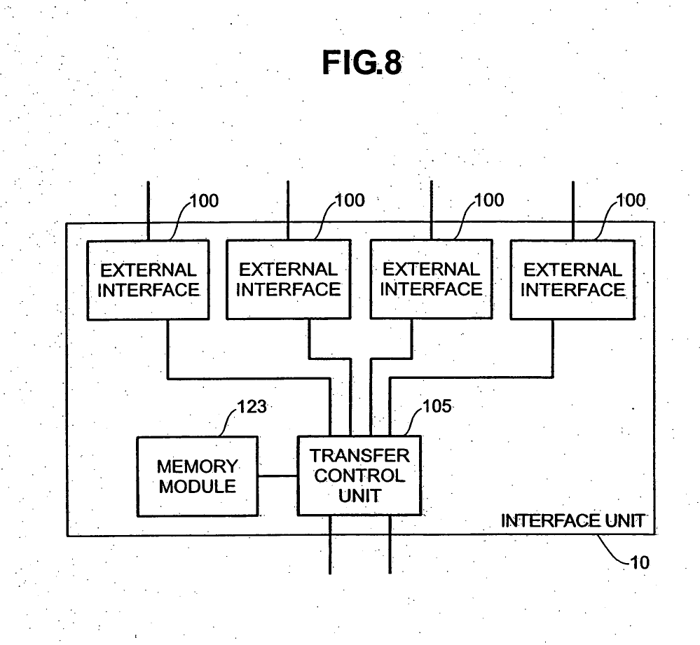

FIG. 8 is a diagram depicting a concrete example of the configuration of the interface unit 10.

The interface unit 10 is comprised of four interfaces (external interfaces) 100 to be connected to the server 3 or hard drives 2, a transfer control unit 105 for controlling the transfer of data/control information with the processor unit 81 or memory unit 21, and memory module 123 for buffering data and storing control information.

The external interface 100 is connected with the transfer control unit 105. Also the memory module 123 is connected to the transfer control unit 105. The transfer control unit 105 also operates as a memory controller for controlling read/write of the data/control information to the memory module 123.

The connection configuration between the external interface 100 or the memory module 123 and the transfer control unit 105 in this case are merely an example, and is not limited to the above mentioned configuration. As long as the data/control information can be transferred from the external interface 100 to the processor unit 81 and memory unit 21 via the transfer control unit 105, any configuration is acceptable.

In the case of the interface unit 10 in FIG. 4, where the data path 91 and the control information path 92 are separated, two data paths 91 and two control information paths 92 are connected to the transfer control unit 106.

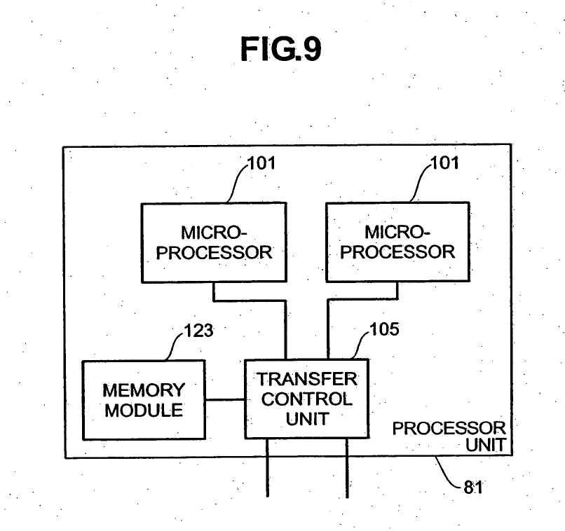

FIG. 9 is a diagram depicting a concrete example of the configuration of the processor unit 81.

The processor unit 21 is comprised of two microprocessors 101, a transfer control unit 105 for controlling the transfer of data/control information with the interface unit 10 or memory unit 21, and a memory module 123. The memory module 123 is connected to the transfer control unit 105. The transfer control unit 105 also operates as a memory controller for controlling read/write of data/control information to the memory module 123. The memory module 123 is shared by the two microprocessors 101 as a main memory, and stores data and control information. The processor unit 21 may have dedicated memory modules for each microprocessor 101 for the number of microprocessors, instead of the memory module 123, which is shared by two microprocessors 101.

The microprocessor 101 is connected to the transfer control unit 105. The microprocessor 101 controls read/write of data to the cache memory of the memory unit 21, directory management of the cache memory, and data transfer between the interface unit 10 and the memory unit 21 based on the control information stored in the control memory module 127 of the memory unit 21.

Specifically, for example, the external interface 100 in the interface unit 10 writes the control information to indicate an access request for read or write of data to the memory module 123 in the processor unit 81. Then the microprocessor 101 reads out the written control information, interprets it, and writes the control information, to indicate which memory unit 21 the data is transferred from the external interface 100 and the parameters to be required for the data transfer, to the memory module 123 in the interface unit 10. The external interface 100 executes data transfer to the memory unit 21 according to that control information and parameters.

The microprocessor 101 executes the data redundant process of data to be written to the hard drives 2 connected to the interface unit 10, that is the so called RAID process. This RAID process may be executed in the interface unit 10 and memory unit 21. The microprocessor 101 also manages the storage area in the storage system 1 (e.g. address transformation between a logical volume and physical volume).

The connection configuration between the microprocessor 101, the transfer control unit 105 and the memory module 123 in this case is merely an example, and is not limited to the above mentioned configuration. As long as data/control information can be mutually transferred between the microprocessor 101, the transfer control unit 105 and the memory module 123, any configuration is acceptable.

If the data path 91 and the control information path 92 are separated, as shown in FIG. 4, the data paths 91 (two paths in this case) and the control information paths 92 (two paths in this case) are connected to the transfer control unit 106 of the processor unit 81.

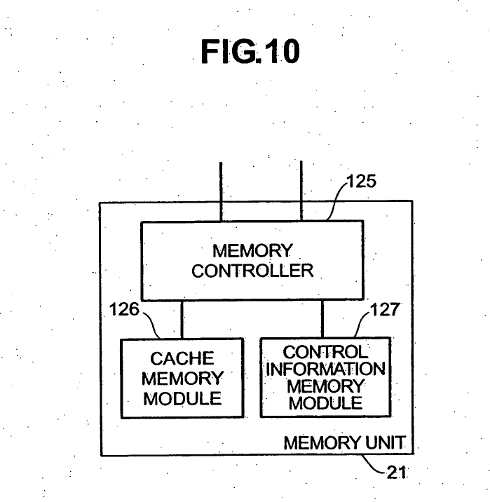

FIG. 10 is a diagram depicting a concrete example of the configuration of the memory unit 21.

The memory unit 21 is comprised of a cache memory module 126, control information memory module 127 and memory controller 125. In the cache memory module 126, data to be written to the hard drives 2 or data read from the hard drives 2 is temporarily stored (hereafter called “caching”). In the control memory module 127, the directory information of the cache memory module 126 (information on a logical block for storing data in cache memory), information for controlling data transfer between the interface unit 10, processor unit 81 and memory unit 21, and management information and configuration information of the storage system 1 are stored. The memory controller 125 controls read/write processing of data to the cache memory module 126 and control information to the control information memory module 127 independently.

The memory controller 125 controls transfer of data/control information between the interface unit 10, processor unit 81 and other memory units 21.

Here the cache memory module 126 and the control memory module 127 may be physically integrated into one [unit], and the cache memory area and the control information memory area may be allocated in logically different areas of one memory space. This makes it possible to decrease the number of memory modules and decrease component cost.

The memory controller 125 may be separated for cache memory module control and for control information memory module control.

If the storage system 1 has a plurality of memory units 21, the plurality of memory units 21 may be divided into two groups, and data and control information to be stored in the cache memory module and control memory module may be duplicated between these groups. This makes it possible to continue operation when an error occurs to one group of cache memory modules or control information memory modules, using the data stored in the other group of cache memory modules or control information memory modules, which improves the reliability of the storage system 1.

In the case when the data path 91 and the control information path 92 are separated, as shown in FIG. 4, the data paths 91 (two paths in this case) and the control information paths 92 (two paths in this case) are connected to the memory controller 128.

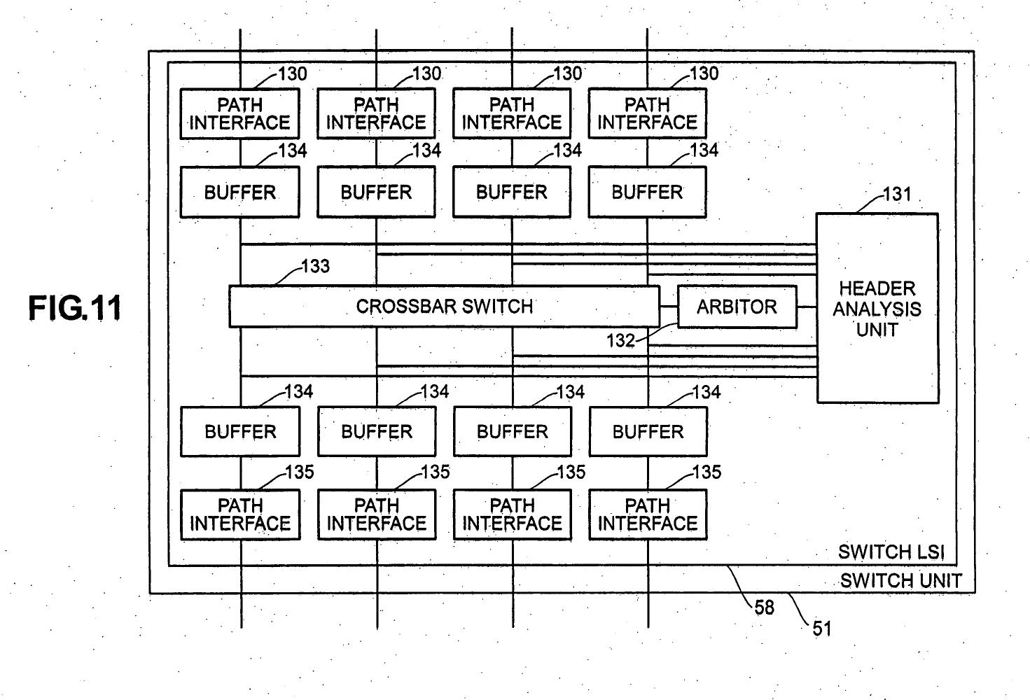

FIG. 11 is a diagram depicting a concrete example of the configuration of the switch unit 51.

The switch unit 51 has a switch LSI 58. The switch LSI 58 is comprised of four path interfaces 130, header analysis unit 131, arbitor 132, crossbar switch 133, eight buffers 134 and four path interfaces 135.

The path interface 130 is an interface where the communication path to be connected with the interface unit 10 is connected. The interface unit 10 and the path interface 130 are connected one-to-one. The path interface 135 is an interface where the communication path to be connected with the processor unit 81 or the memory unit 21 is connected. The processor unit 81 or the memory unit 21 and the path interface 135 are connected one-to-one. In the buffer 134, the packets to be transferred between the interface unit 10, processor unit 81 and memory unit 21 are temporarily stored (buffering).

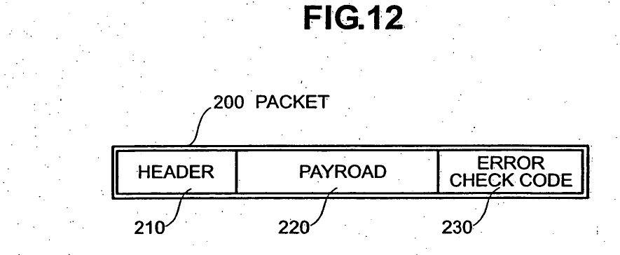

FIG. 12 is a diagram depicting an example of the format of a packet to be transferred between the interface unit 10, processor unit 81 and memory unit 21. A packet is a unit of data transfer in the protocol used for data transfer (including control information) between each unit. The packet 200 has a header 210, payload 220 and error check code 230. In the header 210, at least the information to indicate the transmission source and the transmission destination of the packet is stored. In the payload 220, such information as a command, address, data and status is stored. The error check code 230 is a code to be used for detecting an error which is generated in the packet during packet transfer.

When the path interface 130 or 135 receives a packet, the switch LSI 158 sends the header 210 of the received packet to the header analysis unit 131. The head analysis unit 131 detects the connection request between each path interface based on the information on the packet transmission destination included in the header 210. Specifically, the header analysis unit 131 detects the path interface connected with the unit (e.g. memory unit) at the packet transmission destination specified by the header 210, and generates a connection request between the path interface that received the packet and the detected path interface.

Then the header analysis unit 131 sends the generated connection request to the arbitor 132. The arbitor 132 arbitrates each path interface based on the detected connection request of each path interface. Based on this result, the arbitor 132 outputs the signal to switch connection to the crossbar switch 133. The crossbar switch 133 which received the signal switches connection in the crossbar switch 133 based on the content of the signal, and implements connection between the desired path interfaces.

In the configuration of the present embodiment, each path interface has a buffer one-to-one, but the switch LSI 58 may have one large buffer, and a packet storage area is allocated to each path interface in the [large buffer]. The switch LSI 58 has a memory for storing error information in the switch unit 51.

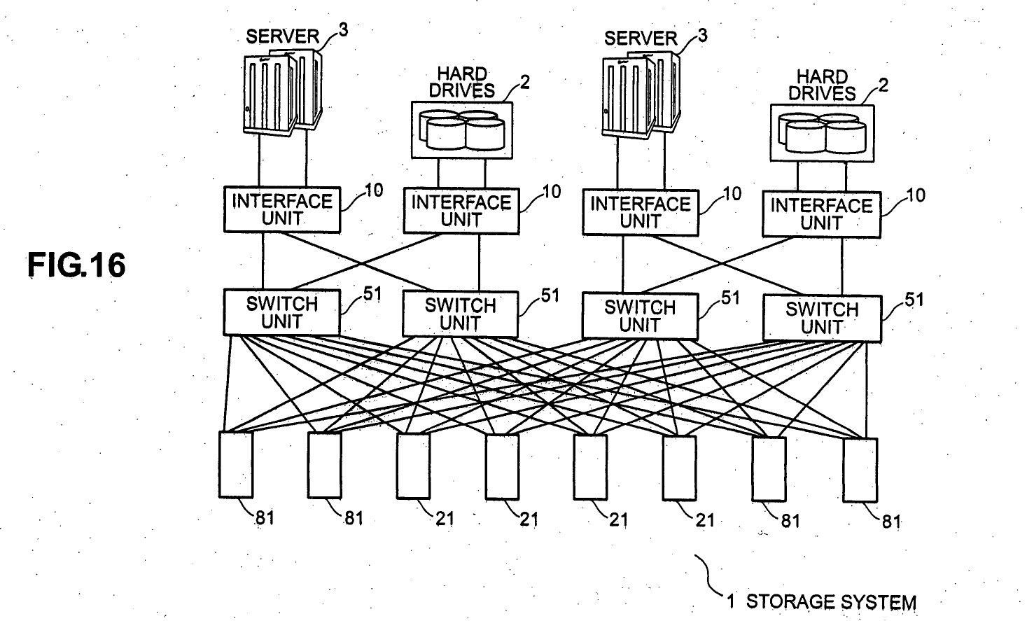

FIG. 16 is a diagram depicting another configuration example of the interconnection 31.

In FIG. 16, the number of path interfaces of the switch unit 51 is increased to ten, and the number of the switch units 51 is increased to four. As a result, the number of interface units 10, processor units 81 and memory units 21 are double those of the configuration in FIG. 2. In FIG. 16, the interface unit 10 is connected only to a part of the switch units 51, but the processor units 81 and memory units 21 are connected to all the switch units 51. This also makes it possible to access from all the interface units 10 to all the memory units 21 and all the processor units 81.

Conversely, each one of the ten interface units may be connected to all the switch units 51, and each of the processor units 81 and memory units 21 may be connected to a part of the switch units. For example, the processor units 81 and memory units 21 are divided into two groups, where one group is connected to two switch units 51 and the other group is connected to the remaining two switch units 51. This also makes it possible to access from all the interface units 10 to all the memory units 21 and all the processor units 81.

Now an example of the process procedure when the data recorded in the hard drives 2 of the storage system 1 is read from the server 3. In the following description, the packets are always used for data transfer which uses the switches 51. In the communication between the processor unit 81 and the interface unit 10, the area for the interface unit 10 to store the control information (information required for data transfer), which is sent from the processor unit 81, is predetermined.

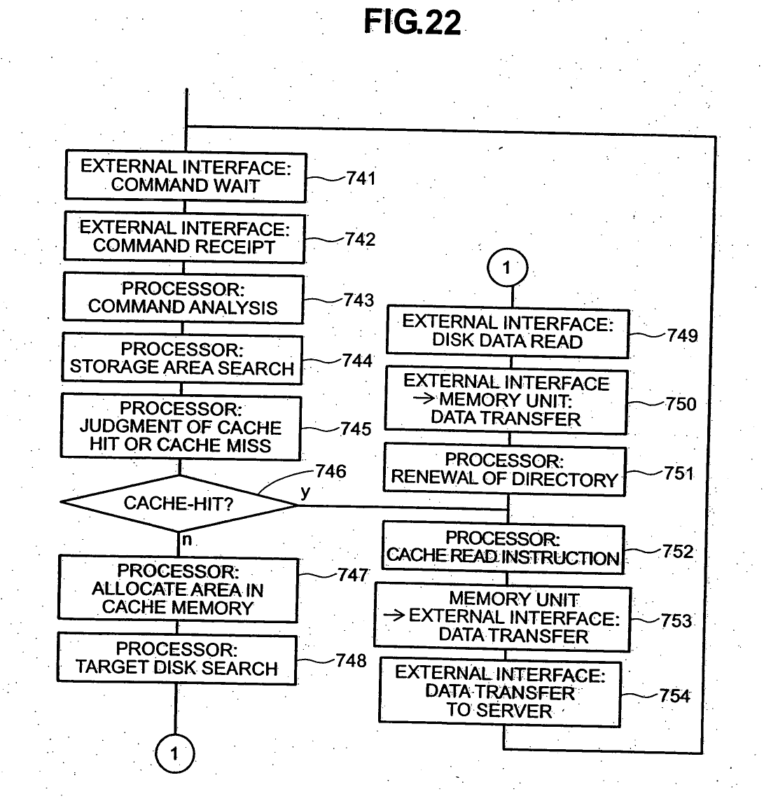

FIG. 22 is a flow chart depicting a process procedure example when the data recorded in the hard disks 2 of the storage system 1 is read from the server 3.

At first, the server 3 issues the data read command to the storage system 1. When the external interface 100 in the interface unit 10 receives the command (742), the external interface 100 in the command wait status (741) transfers the received command to the transfer control unit 105 in the processor unit 81 via the transfer control unit 105 and the interconnection 31 (switch unit 51 in this case). The transfer control unit 105 that received the command writes the received command to the memory module 123.

The microprocessor 101 of the processor unit 81 detects that the command is written to the memory module 123 by polling to the memory module 123 or by an interrupt to indicate writing from the transfer control unit 105. The microprocessor 101, which detected the writing of the command, reads out this command from the memory module 123 and performs the command analysis (743). The microprocessor 101 detects the information that indicates the storage area where the data requested by the server 3 is recorded in the result of command analysis (744).

The microprocessor 101 checks whether the data requested by the command (hereafter also called “request data”) is recorded in the cache memory module 126 in the memory unit 21 from the information on the storage area acquired by the command analysis and the directory information of the cache memory module stored in the memory module 123 in the processor unit 81 or the control information memory module 127 in the memory unit 21 (745).

If the request data exists in the cache memory module 126 (hereafter also called a “cache hit”) (746), the microprocessor 101 transfers the information required for transferring the request data from the cache memory module 126 to the external interface 100 in the interface unit 10, specifically the information of the address in the cache memory module 126 where the request data is stored and the address in the memory module 123, which the interface unit 10 to be the transfer destination has, to the memory module 123 in the interface unit 10 via the transfer control unit 105 in the processor unit 81, the switch unit 51 and the transfer control unit 105 in the interface unit 10.

Then the microprocessor 101 instructs the external interface 100 to read the data from the memory unit 21 (752).

The external interface 100 in the interface unit 10, which received the instruction, reads out the information necessary for transferring the request data from a predetermined area of the memory module 123 in the local interface unit 10. Based on this information, the external interface 100 in the interface unit 10 accesses the memory controller 125 in the memory unit 21, and requests to read out the request data from the cache memory module 126. The memory controller 125 which received the request reads out the request data from the cache memory module 126, and transfers the request data to the interface unit 10 which received the request (753). The interface unit 10 which received the request data sends the received request data to the server 3 (754).

If the request data does not exist in the cache memory module 126 (hereafter also called “cache-miss”) (746), the microprocessor 101 accesses the control memory module 127 in the memory unit 21, and registers the information for allocating the area for storing the request data in the cache memory module 126 in the memory unit 21, specifically information for specifying an open cache slot, in the directory information of the cache memory module (hereafter also called “cache area allocation”) (747). After cache area allocation, the microprocessor 101 accesses the control information memory module 127 in the memory unit 21, and detects the interface unit 10, to which the hard drives 2 for storing the request data are connected (hereafter also called “target interface unit 10”), from the management information of the storage area stored in the control information memory module 127 (748).

Then the microprocessor 101 transfers the information, which is necessary for transferring the request data from the external interface 100 in the target interface init 10 to the cache memory module 126, to the memory module 123 in the target interface unit 10 via the transfer control unit 105 in the processor unit 81, switch unit 51 and the transfer control unit 105 in the target interface unit 10. And the microprocessor 101 instructs the external interface 100 in the target interface unit 10 to read the request data from the hard drives 2, and to write the request data to the memory unit 21.

The external interface 100 in the target interface 10, which received the instruction, reads out the information necessary for transferring request data from the predetermined area of the memory module 123 in the local interface unit 10 based on the instructions. Based on this information, the external interface 100 in the target interface unit 10 reads out the request data from the hard drives 2 (749), and transfers the data which was read out to the memory controller 125 in the memory unit 21. The memory controller 125 writes the received request data to the cache memory module 126 (750). When writing of the request data ends, the memory controller 125 notifies the end to the microprocessor 101.

The microprocessor 101, which detected the end of writing to the cache memory module 126, accesses the control memory module 127 in the memory unit 21, and updates the directory information of the cache memory module. Specifically, the microprocessor 101 registers the update of the content of the cache memory module in the directory information (751). Also the microprocessor 101 instructs the interface unit 10, which received the data read request command, to read the request data from the memory unit 21.

The interface unit 10, which received instructions, reads out the request data from the cache memory module 126, in the same way as the process procedure at cache-hit, and transfers it to the server 3. Thus the storage system 1 reads out the data from the cache memory module or the hard drives 2 when the data read request is received from the server 3, and sends it to the server 3.

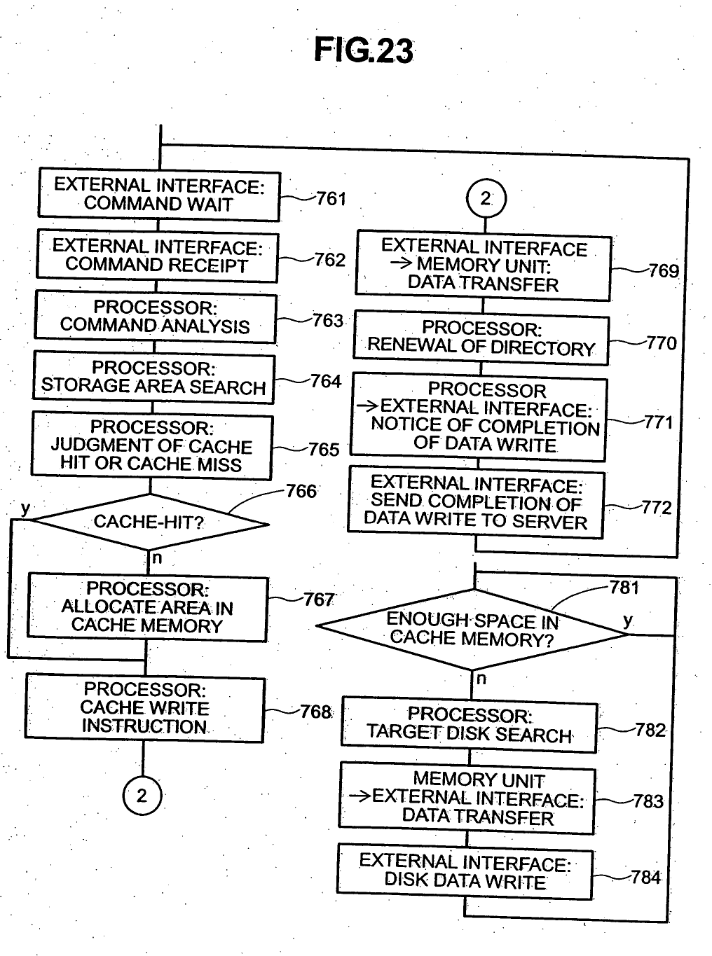

Now an example of the process procedure when the data is written from the server 3 to the storage system 1 will be described. FIG. 23 is a flow chart depicting a process procedure example when the data is written from the server 3 to the storage system 1.

At first, the server 3 issues the data write command to the storage system 1. In the present embodiment, the description assumes that the write command includes the data to be written (hereafter also called “update data”). The write command, however, may not include the update data. In this case, after the status of the storage system 1 is confirmed by the write command, the server 3 sends the update data.

When the external interface 100 in the interface unit 10 receives the command (762), the external interface 100 in the command wait status (761) transfers the received command to the transfer control unit 105 in the processor unit 81 via the transfer control unit 105 and the switch unit 51. The transfer control unit 105 writes the received command to the memory module 123 of the processor unit. The update data is temporarily stored in the memory module 123 in the interface unit 10.

The microprocessor 101 of the processor unit 81 detects that the command is written to the memory module 123 by polling to the memory module 123 or by an interrupt to indicate writing from the transfer control unit 105. The microprocessor 101, which detected writing of the command, reads out this command from the memory module 123, and performs the command analysis (763). The microprocessor 101 detects the information that indicates the storage area where the update data, which the server 3 requests writing, is recorded in the result of command analysis (764). The microprocessor 101 decides whether the write request target, that is the data to be the update target (hereafter called “update target data”), is recorded in the cache memory module 126 in the memory unit 21, based on the information that indicates the storage area for writing the update data and the directory information of the cache memory module stored in the memory module 123 in the processor unit 81 or the control information memory module 127 in the memory unit 21 (765).

If the update target data exists in the cache memory module 126 (hereafter also called “write-hit”) (766), the microprocessor 101 transfers the information, which is required for transferring update data from the external interface 100 in the interface unit 10 to the cache memory module 126, to the memory module 123 in the interface unit 10 via the transfer control unit 105 in the processor unit 81, the switch unit 51 and the transfer control unit 105 in the interface unit 10. And the microprocessor 101 instructs the external interface 100 to write the update data which was transferred from the server 3 to the cache memory module 126 in the memory unit (768).

The external interface 100 in the interface unit 10, which received the instruction, reads out the information necessary for transferring the update data from a predetermined area of the memory module 123 in the local interface unit 10. Based on this read information, the external interface 100 in the interface unit 10 transfers the update data to the memory controller 125 in the memory unit 21 via the transfer control unit 105 and the switch unit 51. The memory controller 125, which received the update data, overwrites the update target data stored in the cache memory module 126 with the request data (769). After the writing ends, the memory controller 125 notifies the end of writing the update data to the microprocessor 101 which sent the instructions.

The microprocessor 101, which detected the end of writing of the update data to the cache memory module 126, accesses the control information memory module 127 in the memory unit 21, and updates the directory information of the cache memory (770). Specifically, the microprocessor 101 registers the update of the content of the cache memory module in the directory information. Along with this, the microprocessor 101 instructs the external interface 100, which received the write request from the server 3, to send the notice of completion of the data write to the server 3 (771). The external interface 100, which received this instruction, sends the notice of completion of the data write to the server 3 (772).

If the update target data does not exist in the cache memory module 126 (hereafter also called “write-miss”) (766), the microprocessor 101 accesses the control memory module 127 in the memory unit 21, and registers the information for allocating an area for storing the update data in the cache memory module 126 in the memory unit 21, specifically, information for specifying an open cache slot in the directory information of the cache memory (cache area allocation) (767). After cache area allocation, the storage system 1 performs the same control as the case of a write-hit. In the case of a write-miss, however, the update target data does not exist in the cache memory module 126, so the memory controller 125 stores the update data in the storage area allocated as an area for storing the update data.

Then the microprocessor 101 judges the vacant capacity of the cache memory module 126 (781) asynchronously with the write request from the server 3, and performs the process for recording the update data written in the cache memory module 126 in the memory unit 21 to the hard drives 2. Specifically the microprocessor 101 accesses the control information memory module 127 in the memory unit 21, and detects the interface unit 10 to which the hard drives 2 for storing the update data are connected (hereafter also called “update target interface unit 10”) from the management information of the storage area (782). Then the microprocessor 101 transfers the information, which is necessary for transferring the update data from the cache memory module 126 to the external interface 100 in the update target interface unit 10, to the memory module 123 in the update target interface unit 10 via the transfer control unit 105 of the processor unit 81, switch unit 51 and transfer control unit 105 in the interface unit 10.

Then the microprocessor 101 instructs the update target interface unit 10 to read out the update data from the cache memory module 126, and transfer it to the external interface 100 in the update target interface unit 10. The external interface 100 in the update target interface unit 10, which received the instruction, reads out the information necessary for transferring the update data from a predetermined area of the memory module 123 in the local interface unit 10. Based on this read information, the external interface 100 in the update target interface unit 10 instructs the memory controller 125 in the memory unit 21 to read out the update data from the cache memory module 126, and transfer this update data from the memory controller 125 to the external interface 100 via the transfer control unit 105 in the update target interface unit 10.

The memory controller 125, which received the instruction, transfers the update data to the external interface 100 of the update target interface unit 10 (783). The external interface 100, which received the update data, writes the update data to the hard drives 2 (784). In this way, the storage system 1 writes data to the cache memory module and also writes data to the hard drives 2, in response to the data write request from the server 3.

In the storage system 1 according to the present embodiment, the management console 65 is connected to the storage system 1, and from the management console 65, the system configuration information is set, system startup/shutdown is controlled, the utilization, operating status and the error information in each unit of the system are corrected, the blockade/replacement process of the error portion is performed when errors occur, and the control program is updated. Here the system configuration information, utilization, operating status and error information are stored in the control information memory module 127 in the memory unit 21. In the storage system 1, an internal LAN (Local Area Network) 91 is installed. Each processor unit 81 has a LAN interface, and the management console 65 and each processor unit 81 are connected via the internal LAN 91. The management console 65 accesses each processor unit 81 via the internal LAN, and executes the above mentioned various processes.

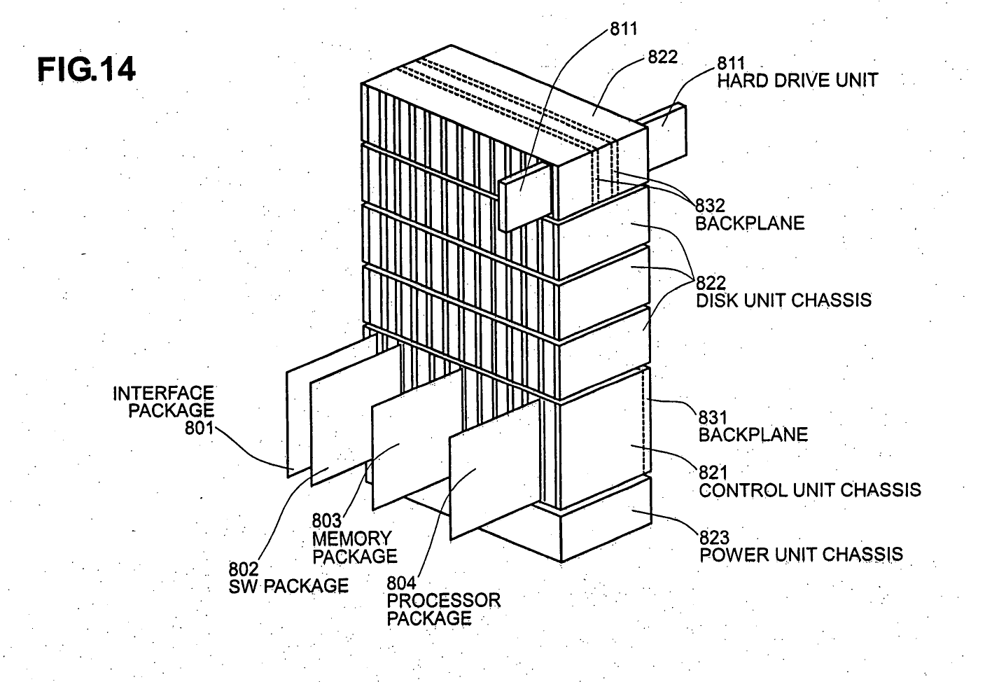

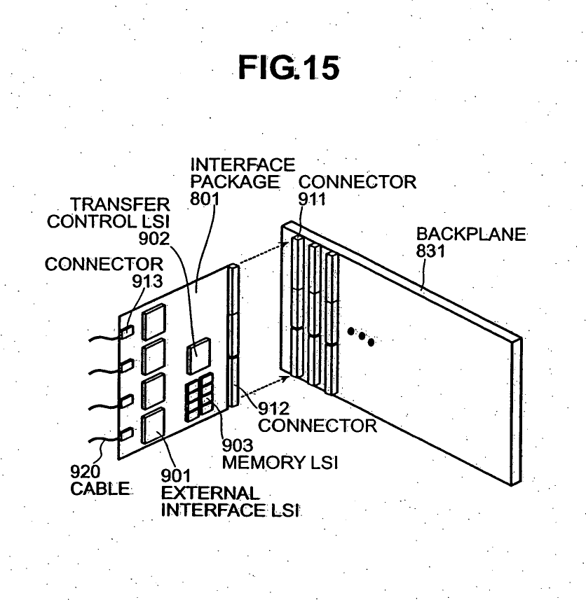

FIG. 14 and FIG. 15 are diagrams depicting configuration examples of mounting the storage system 1 with the configuration according to the present embodiment in a rack.

In the rack to be a frame of the storage system 1 a power unit chassis 823, control unit chassis 821 and a disk unit chassis 822 are mounted. In these chassis, the above mentioned units are packaged respectively. On one surface of the control unit chassis 821, a backplane 831, where signal lines connecting the interface unit 10, switch unit 51, processor unit 81 and memory unit 21 are printed, is disposed (FIG. 15). The backplane 831 is comprised of a plurality of layers of circuit boards where signal lines are printed on each layer. The backplane 831 has a connector 911 to which an interface package 801, SW package 802 and memory package 803 or processor package 804 are connected. The signal lines on the backplane 831 are printed so as to be connected to predetermined terminals in the connector 911 to which each package is connected. Signal lines for power supply for supplying power to each package are also printed on the backplane 831.

The interface package 801 is comprised of a plurality of layers of circuit boards where signal lines are printed on each layer. The interface package 801 has a connector 912 to be connected to the backplane 831. On the circuit board of the interface package 801, signal lines for connecting a signal line between the external interface 100 and the transfer control unit 105 in the configuration of the interface unit 10 shown in FIG. 8, a signal line between the memory module 123 and the transfer control unit 105, and a signal line for connecting the transfer control unit 105 to the switch unit 51 are printed. Also on the circuit board of the interface package 801, an external interface LSI 901 for playing the role of the external interface 100, a transfer control LSI for playing a role of the transfer control unit 105, and a plurality of memory LSIs 903 constituting the memory module 123 are packaged according to the wiring on the circuit board.

A power supply for driving the external interface LSI 901, transfer control LSI 902 and memory LSI 903 and a signal line for a clock are also printed on the circuit board of the interface package 801. The interface package 801 also has a connector 913 for connecting the cable 920, which connects the server 3 or the hard drives 2 and the external interface LSI 901, to the interface package 801. The signal line between the connector 913 and the external interface LSI 901 is printed on the circuit board.

The SW package 802, memory package 803 and processor package 804 have configurations basically the same as the interface package 801. In other words, the above mentioned LSIs which play roles of each unit are mounted on the circuit board, and signal lines which interconnect them are printed on the circuit board. Other packages, however, do not have connectors 913 and signal lines to be connected thereto, which the interface package 801 has.

On the control unit chassis 821, the disk unit chassis 822 for packaging the hard drive unit 811, where a hard drive 2 is mounted, is disposed. The disk unit chassis 822 has a backplane 832 for connecting the hard disk unit 811 and the disk unit chassis. The hard disk unit 811 and the backplane 832 have connectors for connecting to each other. Just like the backplane 831, the backplane 832 is comprised of a plurality of layers of circuit boards where signal lines are printed on each layer. The backplane 832 has a connector to which the cable 920, to be connected to the interface package 801, is connected. The signal line between this connector and the connector to connect the disk unit 811 and the signal line for supplying power are printed on the backplane 832.

A dedicated package for connecting the cable 920 may be disposed, so as to connect this package to the connector disposed on the backplane 832.

Under the control unit chassis 821, a power unit chassis 823, where a power unit for supplying power to the entire storage system 1 and a battery unit are packaged, is disposed.

These chassis are housed in a 19 inch rack (not illustrated). The positional relationship of the chassis is not limited to the illustrated example, but the power unit chassis may be mounted on the top, for example.

The storage system 1 may be constructed without hard drives 2. In this case, the hard drives 2, which exist separately from the storage system 1, and another storage system 1 and storage system 1, are connected via the connection cable 920 disposed in the interface package 801. Also in this case, the hard drives 2 are packaged in the disk unit chassis 822, and the disk unit chassis 822 is packaged in the 19 inch rack dedicated to the disk unit chassis. The storage system 1, which has the hard drives 2, may be connected to another storage system 1. In this case as well, the storage system 1 and another storage system 1 are interconnected via the connection cable 920 disposed in the interface package 801.

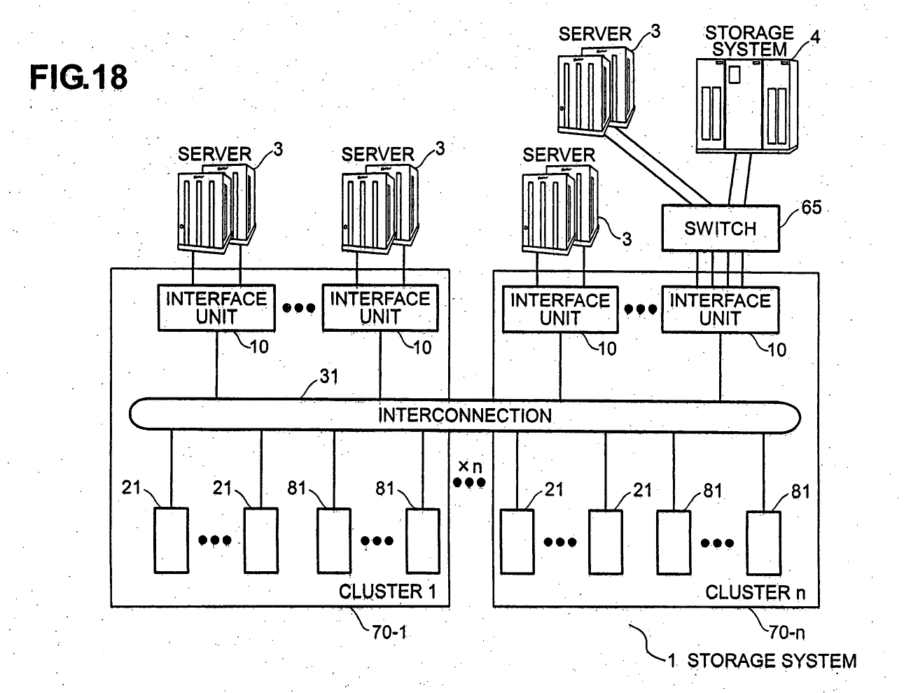

In the above description, the interface unit 10, processor unit 81, memory unit 21 and switch unit are mounted in separate packages respectively, but it is also possible to mount the switch unit 51, processor unit 81 and memory unit 21, for example, in one package together. It is also possible to mount all of the interface unit 10, switch unit 51, processor unit 81 and memory unit 21 in one package. In this case, the sizes of the packages are different, and the width and height of the control unit chassis 821 shown in FIG. 18 must be changed accordingly. In FIG. 14, the package is mounted in the control unit chassis 821 in a format vertical to the floor face, but it is also possible to mount the package in the control unit chassis 821 in a format horizontal with respect to the floor surface. It is arbitrary which combination of the above mentioned interface unit 10, processor unit 81, memory unit 21 and switch unit 51 will be mounted in one package, and the above mentioned packaging combination is an example.

The number of packages that can be mounted in the control unit chassis 821 is physically determined depending on the width of the control unit chassis 821 and the thickness of each package. On the other hand, as the configuration in FIG. 2 shows, the storage system 1 has a configuration where the interface unit 10, processor unit 81 and memory unit 21 are interconnected via the switch unit 51, so the number of each unit can be freely set according to the system scale, the number of connected servers, the number of connected hard drives and the performance to be required. Therefore the number of interface packages 801, memory packages 803 and processor packages 804 can be freely selected and mounted, where the upper limit is the number when the number of SW packages is subtracted from the number of packages that can be mounted in the control unit chassis 821, by sharing the connector with the backplane 831 disposed on the interface package 801, memory package 803 and processor package 804 shown in FIG. 14, and by predetermining the number of SW packages 802 to be mounted and the connector on the backplane 831 for connecting the SW package 802. This makes it possible to flexibly construct a storage system 1 according to the system scale, number of connected servers, number of connected hard drives and the performance that the user demands.

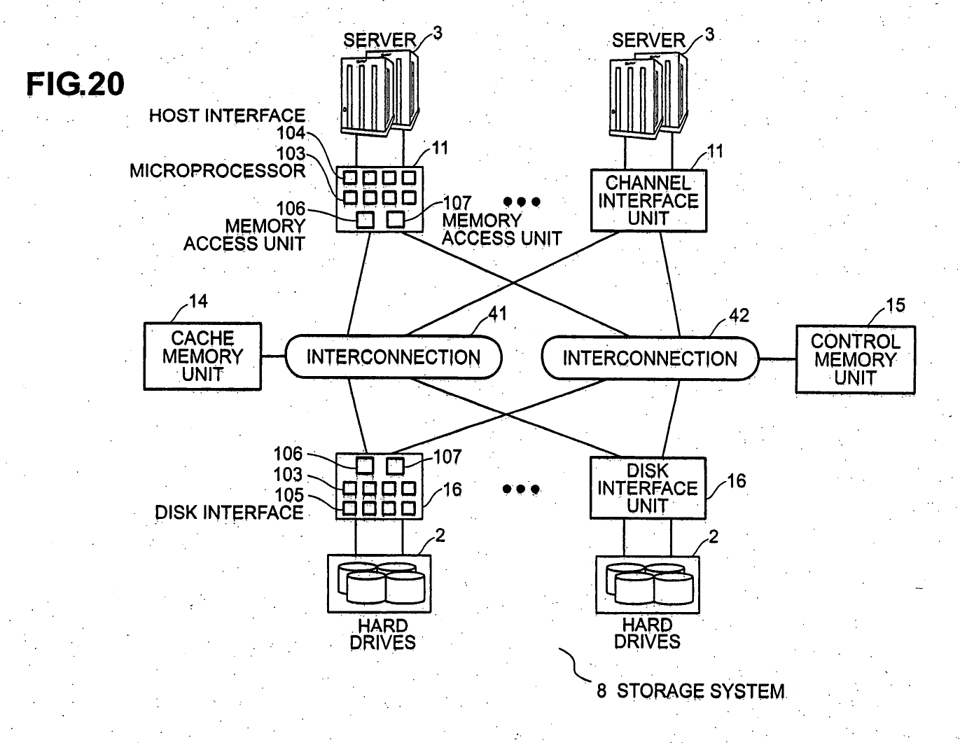

The present embodiment is characterized in that the microprocessor 103 is separated from the channel interface unit 11 and the disk interface unit 16 in the prior art shown in FIG. 20, and is made to be independent as the processor unit 81. This makes it possible to increase/decrease the number of microprocessors independently from the increase/decrease in the number of interfaces connected with the server 3 or hard drives 2, and to provide a storage system with a flexible configuration that can flexibly support the user demands, such as the number of connected servers 3 and hard drives 2, and the system performance.

Also according to the present embodiment, the process which the microprocessor 103 in the channel interface unit 11 used to execute and the process which the microprocessor 103 in the disk interface unit 16 used to execute during a read or write of data are integratedly executed by one microprocessor 101 in the processor unit 81 shown in FIG. 1. This makes it possible to decrease the overhead of the transfer of processing between the respective microprocessors 103 of the channel interface unit and the disk interface unit, which was required in the prior art.

By two microprocessors 101 of the processor unit 81 or two microprocessors 101, each of which is selected from different processor units 81, one of the two microprocessors 101 may execute processing at the interface unit 10 with the server 3 side, and the other may execute processing at the interface unit 10 with the hard drives 2 side.

If the load of the processing at the interface with the server 3 side is greater than the load of the processing at the interface with the hard drives 2 side, more processing power of the microprocessor 101 (e.g. number of processors, utilization of one processor) can be allocated to the former processing. If the degree of load are reversed, more processing power of the microprocessor 101 can be allocated to the latter processing. Therefore the processing power (resource) of the microprocessor can be flexibly allocated depending on the degree of the load of each processing in the storage system.

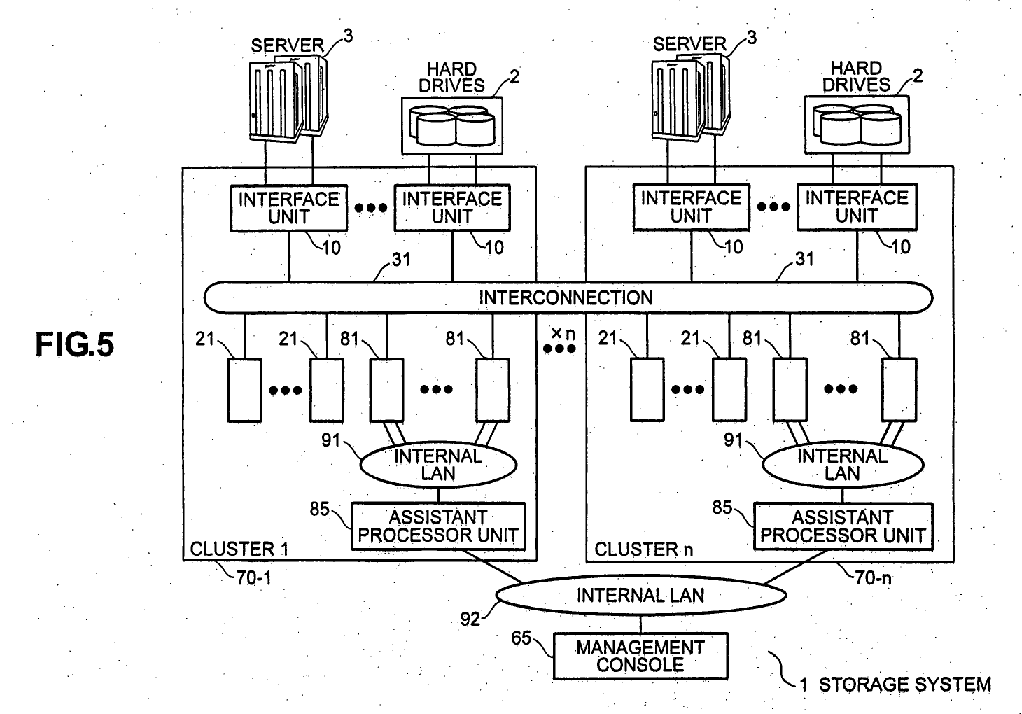

FIG. 5 is a diagram depicting a configuration example of the second embodiment.

The storage system 1 has a configuration where a plurality of clusters 70-1-70-n are interconnected with the interconnection 31. One cluster 70 has a predetermined number of interface units 10 to which the server 3 and hard drives 2 are connected, memory units 21, and processor units 81, and a part of the interconnection. The number of each unit that one cluster 70 has is arbitrary. The interface units 10, memory units 21 and processor units 81 of each cluster 70 are connected to the interconnection 31. Therefore each unit of each cluster 70 can exchange packets with each unit of another cluster 70 via the interconnection 31. Each cluster 70 may have hard drives 2. So in one storage system 1, clusters 70 with hard drives 2 and clusters 70 without hard drives 2 may coexist. Or all the clusters 70 may have hard drives.

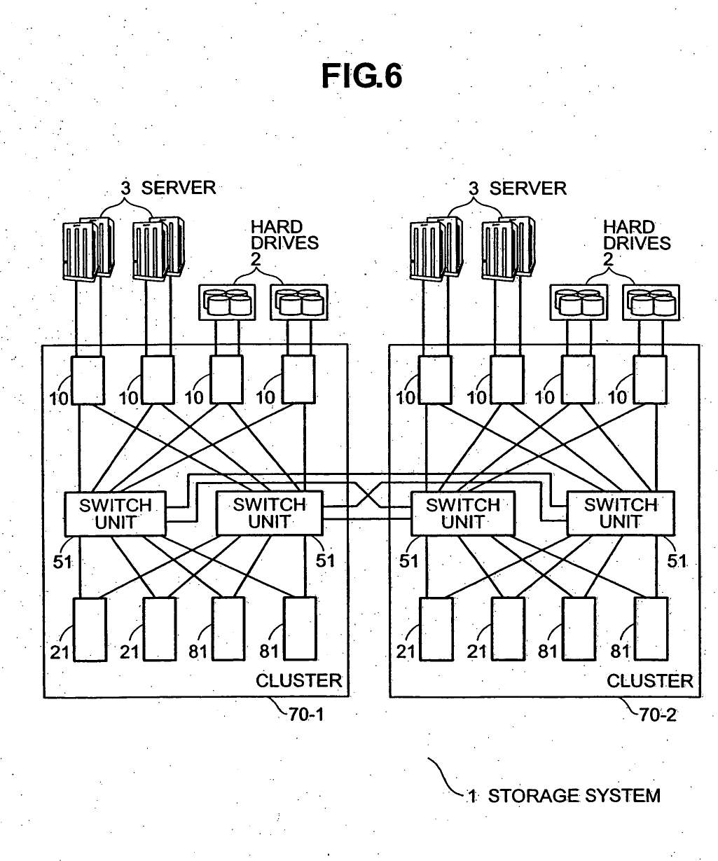

FIG. 6 is a diagram depicting a concrete configuration example of the interconnection 31.

The interconnection 31 is comprised of four switch units 51 and communication paths for connecting them. These switches 51 are installed inside each cluster 70. The storage system 1 has two clusters 70. One cluster 70 is comprised of four interface units 10, two processor units 81 and memory units 21. As mentioned above, one cluster 70 includes two out of the switches 51 of the interconnection 31.

The interface units 10, processor units 81 and memory units 21 are connected with two switch units 51 in the cluster 70 by one communication path respectively. This makes it possible to secure two communication paths between the interface unit 10, processor unit 81 and memory 21, and to increase reliability.

To connect the cluster 70-1 and cluster 70-2, one switch unit 51 in one cluster 70 is connected with the two switch units 51 in another cluster 70 via one communication path respectively. This makes it possible to access extending over clusters, even if one switch unit 51 fails or if a communication path between the switch units 51 fails, which increases reliability.

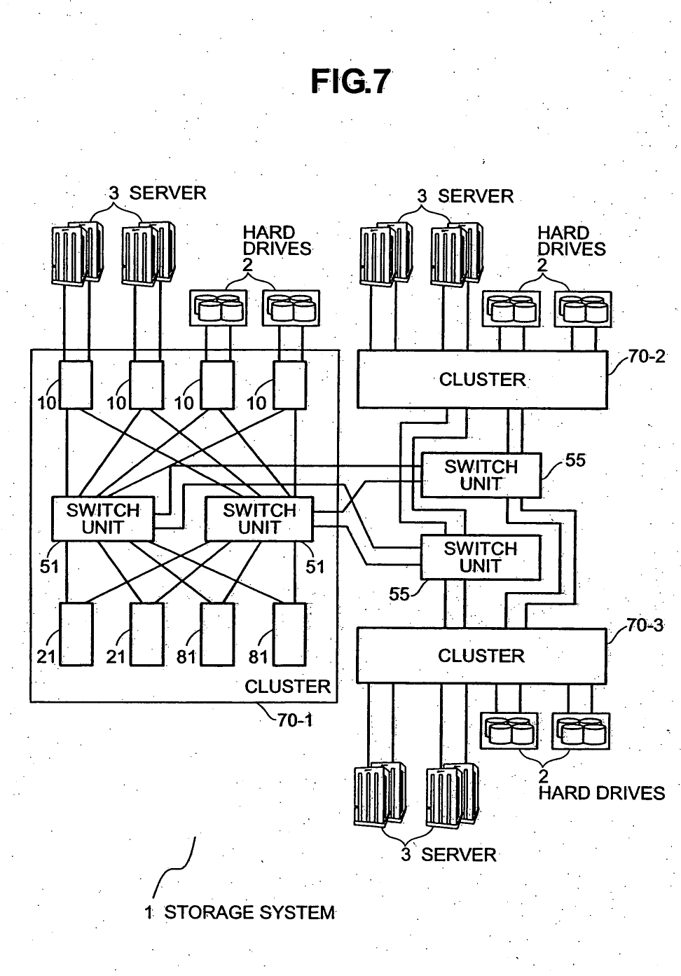

FIG. 7 is a diagram depicting an example of different formats of connection between clusters in the storage system 1. As FIG. 7 shows, each cluster 70 is connected with a switch unit 55 dedicated to connection between clusters. In this case, each switch unit 51 of the clusters 70-1-3 is connected to two switch units 55 by one communication path respectively. This makes it possible to access extending over clusters, even if one switch unit 55 fails or if the communication path between the switch unit 51 and the switch unit 55 fails, which increases reliability.

Also in this case, the number of connected clusters can be increased compared with the configuration in FIG. 6. In other words, the number of communication paths which can be connected to the switch unit 51 is physically limited. But by using the dedicated switch 55 for connection between clusters, the number of connected clusters can be increased compared with the configuration in FIG. 6.

In the configuration of the present embodiment as well, the microprocessor 103 is separated from the channel interface unit 11 and the disk interface unit 16 in the prior art shown in FIG. 20, and is made to be independent in the processor unit 81. This makes it possible to increase/decrease the number of microprocessors independently from the increase/decrease of the number of connected interfaces with the server 3 or hard drives 2, and can provide a storage system with a flexible configuration which can flexibly support user demands for the number of connected servers 3 and hard drives 2, and for system performance.

In the present embodiment as well, data read and write processing, the same as the first embodiment, are executed. This means that in the present embodiment as well, processing which used to be executed by the microprocessor 103 in the channel interface unit 11 and processing which used to be executed by the microprocessor 103 in the disk interface unit 16 during data read or write are integrated and processed together by one microprocessor 101 in the processor unit 81 in FIG. 1. This makes it possible to decrease the overhead of the transfer of processing between each microprocessor 103 of the channel interface unit and the disk interface unit respectively, which is required in the prior art.

When data read or write is executed according to the present embodiment, data may be written or read from the server 3 connected to one cluster 70 to the hard drives 2 of another cluster 70 (or a storage system connected to another cluster 70). In this case as well, read and write processing described in the first embodiment are executed. In this case, the processor unit 81 of one cluster can acquire information to access the memory unit 21 of another cluster 70 by making the memory space of the memory unit 21 of an individual cluster 70 to be one logical memory space in the entire storage system 1. The processor unit 81 of one cluster can instruct the interface unit 10 of another cluster to transfer data.

The storage system 1 manages the volume comprised of hard drives 2 connected to each cluster in one memory space so as to be shared by all the processor units.

In the present embodiment, just like the first embodiment, the management console 65 is connected to the storage system 1, and the system configuration information is set, the startup/shutdown of the system is controlled, the utilization of each unit in the system, operation status and error information is controlled, the blockage/replacement processing of the error portion is performed when errors occur, and the control program is updated from the management console 65. Here, configuration information, utilization, operating status and error information of the system are stored in the control information memory module 127 in the memory unit 21. In the case of the present embodiment, the storage system 1 is comprised of a plurality of clusters 70, so a board which has an assistant processor (assistant processor unit 85) is disposed for each cluster 70. The assistant processor unit 85 plays a role of transferring the instructions from the management console 65 to each processor unit 81 or transferring the information collected from each processor unit 81 to the management console 65. The management console 65 and the assistant processor unit 85 are connected via the internal LAN 92. In the cluster 70, the internal LAN 91 is installed, and each processor unit 81 has a LAN interface, and the assistant processor unit 85 and each processor unit 81 are connected via the internal LAN 91. The management console 65 accesses each processor unit 81 via the assistant processor unit 85, and executes the above mentioned various processes. The processor unit 81 and the management console 65 may be directly connected via the LAN, without the assistant processor.

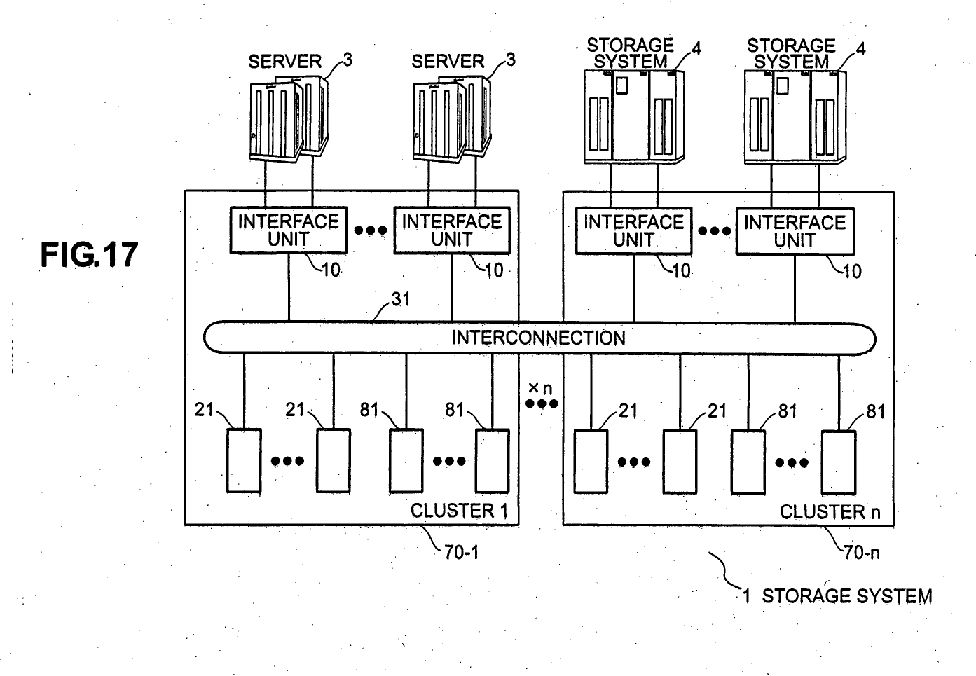

FIG. 17 is a variant form of the present embodiment of the storage system 1. As FIG. 17 shows, another storage system 4 is connected to the interface unit 10 for connecting the server 3 or hard drives 2. In this case, the storage system 1 stores the information on the storage area (hereafter also called “volume”) provided by another storage system 4 and data to be stored in (or read from) another storage system 4 in the control memory module 126 and cache memory module 127 in the cluster 70, where the interface unit 10, to which another storage system 4 is connected, exists.

The microprocessor 101 in the cluster 70, to which another storage system 4 is connected, manages the volume provided by another storage system 4 based on the information stored in the control information memory module 127. For example, the microprocessor 101 allocates the volume provided by another storage system 4 to the server 3 as a volume provided by the storage system 1. This makes it possible for the server 3 to access the volume of another storage system 4 via the storage system 1.

In this case, the storage system 1 manages the volume comprised of local hard drives 2 and the volume provided by another storage system 4 collectively.

In FIG. 17, the storage system 1 stores a table which indicates the connection relationship between the interface units 10 and servers 3 in the control memory module 127 in the memory unit 21. And the microprocessor 101 in the same cluster 70 manages the table. Specifically, when the connection relationship between the servers 3 and the host interfaces 100 is added or changed, the microprocessor 101 changes (updates, adds or deletes) the content of the above mentioned table. This makes communication and data transfer possible via the storage system 1 between a plurality of servers 3 connected to the storage system 1. This can also be implemented in the first embodiment.

In FIG. 17, when the server 3, connected to the interface unit 10, transfers data with the storage system 4, the storage system 1 transfers data between the interface unit 10 to which the server 3 is connected and the interface unit 10 to which the storage system 4 is connected via the interconnection 31. At this time, the storage system 1 may cache the data to be transferred in the cache memory module 126 in the memory unit 21. This improves the data transfer performance between the server 3 and the storage system 4.

In the present embodiment, the configuration of connecting the storage system 1 and the server 3 and another storage system 4 via the switch 65, as shown in FIG. 18, is possible. In this case, the server 3 accesses the server 3 and another storage system 4 via the external interface 100 in the interface unit 10 and the switch 65. This makes it possible to access from the server 3 connected to the storage system 1 to the server 3 and another storage system 4, which are connected to a switch 65 or a network comprised of a plurality of switches 65.

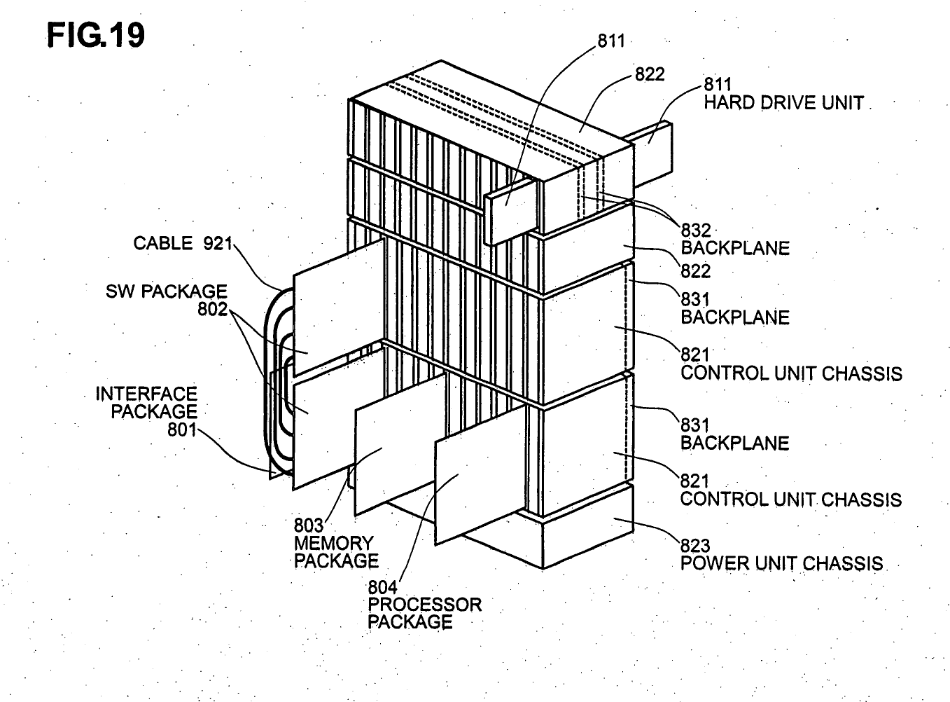

FIG. 19 is a diagram depicting a configuration example when the storage system 1, with the configuration shown in FIG. 6, is mounted in a rack.

The mounting configuration is basically the same as the mounting configuration in FIG. 14. In other words, the interface unit 10, processor unit 81, memory unit 21 and switch unit 51 are mounted in the package and connected to the backplane 831 in the control unit chassis 821.

In the configuration in FIG. 6, the interface units 10, processor units 81, memory units 21 and switch units 51 are grouped as a cluster 70. So one control unit chassis 821 is prepared for each cluster 70. Each unit of one cluster 70 is mounted in one control unit chassis 821. In other words, packages of different clusters 70 are mounted in a different control unit chassis 821. Also for the connection between clusters 70, the SW packages 802 mounted in different control unit chassis are connected with the cable 921, as shown in FIG. 19. In this case, the connector for connecting the cable 921 is mounted in the SW package 802, just like the interface package 801 shown in FIG. 19.

The number of clusters mounted in one control unit chassis 821 may be one or zero. And the number of clusters to be mounted in one control unit chassis 821 may be 2.

In the storage system 1 with the configuration in embodiments 1 and 2, commands received by the interface unit 10 are decoded by the processor unit 81. However, there are many protocols followed by the commands to be exchanged between the server 3 and the storage system 1, so it is impractical to perform the entire protocol analysis process by a general processor. Protocols here includes the file I/O (input/output) protocol using a file name, iSCSI (internet Small Computer System interface) protocol and the protocol used when a large computer (main frame) is used as the server (channel command word: CCW), for example.

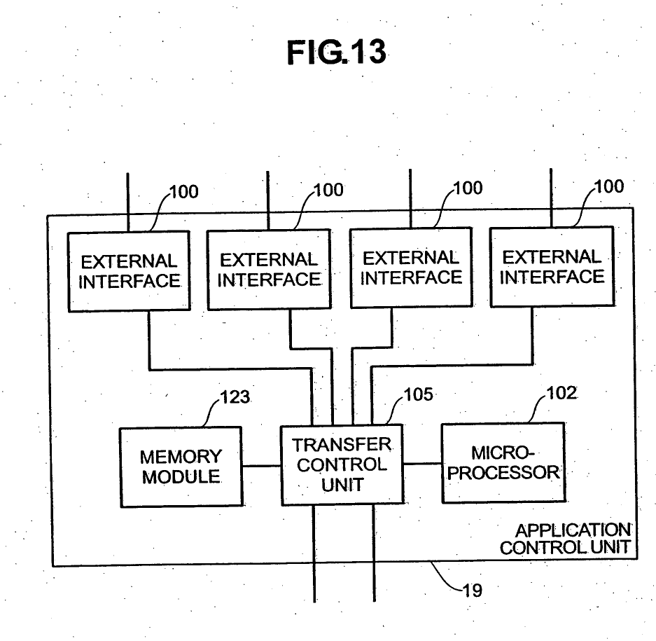

So in the present embodiment, a dedicated processor for processing these protocols at high-speed is added to all or a part of the interface units 10 of the embodiments 1 and 2. FIG. 13 is a diagram depicting an example of the interface unit 10, where the microprocessor 102 is connected to the transfer control unit 105 (hereafter this interface unit 10 is called “application control unit 19”).

The storage system 1 of the present embodiment has the application control unit 19, instead of all or a part of the interface units 10 of the storage system 1 in the embodiments 1 and 2. The application control unit 19 is connected to the interconnection 31. Here the external interfaces 100 of the application control unit 19 are assumed to be external interfaces which receive only the commands following the protocol to be processed by the microprocessor 102 of the application control unit 19. One external interface 100 may receive a plurality of commands following different protocols.

The microprocessor 102 executes the protocol transformation process together with the external interface 100. Specifically, when the application control unit 19 receives an access request from the server 3, the microprocessor 102 executes the process for transforming the protocol of the command received by the external interface into the protocol for internal data transfer.

It is also possible to use the interface unit 10 as is, instead of preparing a dedicated application control unit 19, and one of the microprocessors 101 in the processor unit 81 is used dedicated for protocol processing.

The data read and the data write process in the present embodiment are performed in the same way as the first embodiment. In the first embodiment, however, the interface unit 10, which received the command, transfers it to the processor unit 81 without command analysis, but in the present embodiment, the command analysis process is executed in the application control unit 19. And the application control unit 19 transfers the analysis result (e.g. content of the command, destination of data) to the processor unit 81. The processor unit 81 controls data transfer in the storage system 1 based on the analyzed information.

As another embodiment of the present invention, the following configuration is also possible. Specifically, it is a storage system comprising a plurality of interface units [each of] which has an interface with a computer or hard disk drive, a plurality of memory units [each of] which has a cache memory for storing data to be read from/written to the computer or the hard disk drive, and a control memory for storing control information of the system, and a plurality of processor units [each of] which has a microprocessor for controlling read/write data between the computer and the hard disk drive, wherein the plurality of interface units, the plurality of memory units and the plurality of processor units are interconnected with interconnection which further comprises at least one switch unit, and data or control information is transmitted/received between the plurality of interface units, the plurality of memory units, and the plurality of processor units via the interconnection.

In this configuration, the interface unit, memory unit or processor unit have a transfer control unit for controlling the transmission/reception of data or control information. In this configuration, the interface units are mounted on the first circuit board, the memory units are mounted on the second circuit board, the processor units are mounted on the third circuit board, and at least one switch unit is mounted on the fourth circuit board. Also this configuration also comprises at least one backplane on which signal lines connecting between the first to fourth circuit boards are printed, and which has the first connector for connecting the first to fourth circuit boards to the printed signal lines. Also in the present configuration, the first to fourth circuit boards further comprise a second connector to be connected to the first connector of the backplane.

In the above mentioned aspect, the total number of circuit boards that can be connected to the backplane may be n, and the number of fourth circuit boards and connection locations thereof may be predetermined, so that the respective number of first, second and third circuit boards to be connected to the backplane can be freely selected in a range where the total number of first to fourth circuit boards does not exceed n.

Another aspect of the present invention may have the following configuration. Specifically, this is a storage system comprising a plurality of clusters, further comprising a plurality of interface units [each of] which has an interface with a computer or a hard disk drive, a plurality of memory units [each of] which has a cache memory for storing data to be read from/written to the computer or the hard disk drive and a control memory for storing the control information of the system, and a plurality of processor units [each of] which has a microprocessor for controlling the read/write of data between the computer and the hard disk drive.

In this configuration, the plurality of interface units, plurality of memory units and plurality of processor units which each cluster has are interconnected extending over the plurality of clusters by an interconnection which is comprised of a plurality of switch units. By this, data or control information is transmitted/received between the plurality of interface units, plurality of memory units and plurality of processor units in each cluster via the interconnection. Also in this configuration, the interface unit, memory unit and processor unit are connected to the switch respectively, and further comprise a transfer control unit for controlling the transmission/reception of data or control information.

Also in this configuration, the interface units are mounted on the first circuit board, the memory units are mounted on the second circuit board, the processor units are mounted on the third circuit board, and at least one of the switch units is mounted on the fourth circuit board. And this configuration further comprises a plurality of backplanes on which signal lines for connecting the first to fourth circuit boards are printed and has a first connector for connecting the first to fourth circuit boards to the printed signal line, and the first to fourth circuit board further comprise a second connector for connecting the backplanes to the first connector. In this configuration, the cluster is comprised of a backplane to which the first to fourth circuit boards are connected. The number of clusters and the number of backplanes may be equal in the configuration.

In this configuration, the fourth circuit board further comprises a third connector for connecting a cable, and signal lines for connecting the third connector and switch units are wired on the fourth board. This allows connecting the clusters interconnecting the third connectors by a cable.

As another aspect of the present invention, the following configuration is also possible. Specifically, this is a storage system comprising an interface unit which has an interface with the computer or the hard disk drive, a memory unit which has a cache memory for storing data to be read from/written to the computer or the hard disk drive, and a control memory for storing control information of the system, and a processor unit which has a microprocessor for controlling the read/write of data between a computer and a hard disk drive, wherein the interface unit, memory unit and processor unit are interconnected by an interconnection, which further comprises at least one switch unit. In this configuration, data or control information is transmitted/received between the interface unit, memory unit and processor unit via the interconnection.

In this configuration, the interface unit is mounted on the first circuit board, and the memory unit, processor unit and switch unit are mounted on the fifth circuit board. This configuration further comprises at least one backplane on which signal lines for connecting the first and fifth circuit boards are printed, and which has a fourth connector for connecting the first and fifth circuit boards to the printed signal lines, wherein the first and fifth circuit boards further comprise a fifth connector for connecting to the fourth connector of the backplane.

As another aspect of the present invention, the following configuration is possible. Specifically, this is a storage system comprising an interface unit which has an interface with a computer or a hard disk drive, a memory unit which has a cache memory for storing data to be read from/written to the computer or the hard disk drive and a control memory for storing control information of the system, and a processor unit which has a microprocessor for controlling the read/write of data between the computer and the hard disk drive, wherein the interface unit, memory unit and processor unit are interconnected by an interconnection which further comprises at least one switch unit. In this configuration, the interface unit, memory unit, processor unit and switch unit are mounted on a sixth circuit board.

According to the present invention, a storage system with a flexible configuration which can support user demands for the number of connected servers, number of connected hard disks and system performance can be provided. The bottleneck of shared memory of the storage system is solved, a small scale configuration can be provided with low cost, and a storage system which can implement a scalability of cost and performance, from a small scale to a large scale configuration, can be provided.

1-20. (canceled)

21. A storage device comprising:
an interface unit for connecting an external device;
a memory unit for storing data received at said interface unit;
a processor unit that controls the storing of data received at said interface unit to said memory unit; and
plural disk units that the data stored in said memory unit is stored in by said processor unit;
wherein said interface unit, said memory unit, and said processor unit are connected by a first backplane,
said first backplane has plural first connectors for changing the number of said processor units, and
said plural disk units are connected by a second backplane.

22. The storage device according to claim 21, wherein
said interface unit, said memory unit, and said processor unit each have a connector for connecting to said first backplane.

23. The storage device according to claim 21, wherein
said interface unit, said memory unit, said processor unit and said first backplane are included within a first chassis.

24. The storage device according to claim 21,
said plural disk units and said second backplane are included within a second chassis.

25. The storage device according to claim 21, wherein
said processor unit operates with said external device and said disk unit.

26. The storage device according to claim 21, wherein
said processor unit has plural microprocessors and assigns a microprocessor to operate in accordance with load against said external device and said disk unit.

27. A storage device comprising:
an interface unit for connecting an external device;
a memory unit for storing data received at said interface unit;
a processor unit that controls the storing of data received at said interface unit to said memory unit; and
plural disk units that the data stored in said memory unit is stored in said processor unit;
wherein said interface unit, said memory unit, and said processor unit are connected by a first backplane,
said first backplane has plural first connectors for changing said interface unit, and
said plural disk units are connected by a second backplane.

28. The storage device according to claim 21, wherein
said interface unit, said memory unit, and said processor unit each have a connector for connecting to said first backplane. I

29. The storage device according to claim 27, wherein
said interface unit, said memory unit, said processor unit and said first backplane are included within a first chassis.

30. The storage device according to claim 27,
said plural disk units and said second backplane are included within a second chassis.

31. The storage device according to claim 27, wherein
said processor unit operates with said external device and said disk unit.

32. The storage device according to claim 27, wherein
said processor unit has plural microprocessors and assigns a microprocessor to operate in accordance with load against said external device and said disk unit.

33. A storage device comprising:
an interface unit connected to external device, and that receives data sent from said external device;
a memory unit that stores data received at said interface unit;
plural disk units that the data stored in said memory unit is stored in said processor unit; and
a processor unit that stores data received at said interface unit to said memory unit, or controls the storing of data stored in said memory unit to said plural disk units;
wherein it is possible to change the number of said processor unit in case that said interface unit is not increased or decreased.

34. A storage device according to claim 33, wherein
said processor unit is increased or decreased on condition of storing data in said plural disk units by said processor unit's control.

35. A storage device according to claim 33, wherein
said processor unit operates with said external device and said disk unit.

36. The storage device according to claim 33, wherein
said processor unit has plural microprocessors and assigns a microprocessor to operate in accordance with load against said external device and said disk unit.

37. A storage device comprising:
an interface unit for connecting an external device;
a memory unit for storing data received at said interface unit;
a processor unit that controls the storing of data received at said interface unit to said memory unit; and
plural disk units that the data stored in said memory unit is stored in said processor unit; wherein said interface unit, said memory unit, said processor unit and said disk unit are each mounted on a first board, a second board, a third board, and a fourth board respectively; and
said first board, said second board, and said third board are connected by a first backplane; and
said fourth board are connected by a second backplane.

38. The storage device according to claim 37, wherein
said first board, said second board, and said third board each have a connector respectively for connecting to said first backplane.

39. The storage device according to claim 37, wherein
said first board, said second board, and said third board are included within a first chassis.

40. The storage device according to claim 37,
said fourth board are included within a second chassis.

41. The storage device according to claim 21, further comprising:
a switch unit that relays data or control information sent or received among said interface unit, said memory unit, and said processor unit; wherein
said switch unit is connected by said first backplane.

42. The storage device according to claim 21, wherein
said switch unit has a connector for connecting to said first backplane.

43. The storage device according to claim 41, wherein
said interface unit, said memory unit, said processor unit, said switch unit and said first backplane are included within a first chassis.

44. The storage device according to claim 41,
said plural disk units and said second backplane are included within a second chassis.

45. The storage device according to claim 41,
wherein said processor unit operates with said external device and said disk unit.

46. The storage device according to claim 41, wherein
said processor unit has plural microprocessors and assigns a microprocessor to operate in accordance with load against said external device and said disk unit.

47. The storage device according to claim 27, further comprising:
a switch unit that relays data or control information sent or received among said interface unit, said memory unit, and said processor unit; wherein
said switch unit is connected by said first backplane.

48. The storage device according to claim 47,
wherein said switch unit has a connector for connecting to said first backplane.

49. The storage device according to claim 47,
wherein said interface unit, said memory unit, said processor unit, said switch unit and said first backplane are included within a first chassis.

50. The storage device according to claim 47,
said plural disk units and said second backplane are included within a second chassis.

51. The storage device according to claim 47,
wherein said processor unit operates with said external device and said disk unit.

52. The storage device according to claim 47, wherein
said processor unit has plural microprocessors and assigns a microprocessor to operate in accordance with load against said external device and said disk unit.

53. The storage device according to claim 47, further comprising:
a switch unit that relays data or control information sent or received among said interface unit, said memory unit, and said processor unit;
wherein it is possible to change the number of said processor unit in case that said interface unit is not increased or decreased.

54. A storage device according to claim 47, wherein
said processor unit is increased or decreased on condition of storing data in said plural disk units by said processor unit's control.

55. A storage device according to claim 47, wherein
said processor unit operates with said external device and said disk unit.

56. The storage device according to claim 47, wherein
said processor unit has plural microprocessors and assigns a microprocessor to operate in accordance with load against said external device and said disk unit.

57. The storage device according to claim 37, further comprising:
a switch unit that relays data or control information sent or received among said interface unit, said memory unit, and said processor unit; wherein
said switch unit is mounted on a fifth board; and
said fifth board is connected by said first backplane.

58. The storage device according to claim 57, wherein
said fifth board has a connector for connecting to said first backplane.

59. The storage device according to claim 57, wherein
said first board, said second board, said third board and said fifth board are included within a first chassis.

60. The storage device according to claim 57,
said fourth board are included within a second chassis.
